(19) United States
(12) Patent Application Publication
(10) Pub. No.: US 2014/0213317 A1
(43) Pub. Date: Jul. 31, 2014

(54) STATION SIDE DEVICE, POWER-SAVING CONTROL SYSTEM, AND POWER-SAVING CONTROL METHOD

(71) Applicants: Tomonaga Ida, Tokyo (JP); Masayuki Sato, Tokyo (JP); Fumihiko Tano, Tokyo (JP); Takeshi Suehiro, Tokyo (JP)

(72) Inventors: Tomonaga Ida, Tokyo (JP); Masayuki Sato, Tokyo (JP); Fumihiko Tano, Tokyo (JP); Takeshi Suehiro, Tokyo (JP)

(73) Assignee: Mitsubishi Electric Corporation, Chiyoda-ku (JP)

(21) Appl. No.: 14/239,639

(22) PCT Filed: Dec. 26, 2012
(86) PCT No.: PCT/JP2012/083710

§ 371 Date: Feb. 19, 2014

(30) Foreign Application Priority Data
Jan. 17, 2012 (JP) 2012-007009

(51) Int. Cl. H04W 52/02

(52) U.S. Cl. CPC H04W 52/0206
USPC 455/522

(57) ABSTRACT

A station side device includes a first requesting unit that requests a counterpart communication device to perform a power saving operation of alternately performing execution and suspension of communication at preset time intervals; a phase specifying unit that specifies a first phase of the power saving operation performed by the counterpart communication device and a second phase corresponding to the first phase in the power saving operation of the station side device, based on communication performed with the counterpart communication device; a time-difference calculating unit that calculates a difference between the first phase and the second phase; and a second requesting unit that requests again the counterpart communication device to perform the power saving operation based on the calculated difference.

### FIELD

The present invention relates to a station side device, a power-saving control system, and a power-saving control method.

### BACKGROUND

A PON (Passive Optical Network) system is known as a communication system that utilizes optical communication. The PON system includes two types of communication devices, that is, a station side device (OLT (Optical Line Terminal)) placed on the side that provides services and a subscriber side device (ONU (Optical Network Unit)) placed on the side that uses the services.

In the PON system, when logical connections are established between the station side device and the subscriber side devices, the logical connections between the station side device and the subscriber side devices are then maintained even when there is no data to be transmitted or received, to put a high priority on responsiveness. However, these logical connections are generally used for a limited time of the day and power is wasted during the rest of the day. Therefore, various techniques for reducing the power wasted in such a system have been proposed.

Patent Literature 1 discloses a technique in which a station side device monitors traffics in the downstream direction (downstream traffics) transmitted from a higher-level device with respect to the station side device to subscriber side devices and, when the downstream traffics for a certain period of time are below a certain amount, the state shifts to a power saving state in which effective data is transmitted by an optical signal at a lower speed and with a lower output intensity than in the normal operating state.

Furthermore, Patent Literature 2 discloses a technique in which a station side device monitors the operating state of subscriber side devices and, when a subscriber side device enters a non-operating state, the transmission band is canceled that has been allocated to the subscriber side device by the station side device when the subscriber side device has been in the operating state, thereby suspending communication performed with the subscriber side device in the non-operating state.

### CITATION LIST

### Patent Literatures

Patent Literature 1: Japanese Patent Application Laid-open No. 2011-205329

Patent Literature 2: Japanese Patent Application Laid-open No. 2001-160820

### SUMMARY

### Technical Problem

While more than a certain level of power saving effect can be expected when the techniques disclosed in Patent Literatures 1 and 2 are used, a greater power saving effect can be expected when both of the station side device and the subscriber side devices are brought into the communication suspension state (sleep state). However, to bring the station side device into the communication suspension state, it is required that all the subscriber side devices that perform communication with the station side device are in the communication suspension state. Therefore, there has been a problem in that the station side device needs to monitor the communication state of all the subscriber side devices that perform communication. Moreover, there has been a problem in that when the number of the subscriber side devices is larger, the time during which all the subscriber side devices are in the communication suspension state at the same time is shorter and thus the power saving effect cannot be expected.

The present invention has been achieved in view of these problems, and an object of the present invention is to provide a station side device, a power-saving control system, and a power-saving control method that can save power more efficiently in both of the station side device and the subscriber side device.

### Solution to Problem

A station side device according to a first aspect of the present invention includes a first requesting unit that requests a counterpart communication device to perform a power saving operation of alternately performing execution and suspension of communication at preset time intervals; a phase specifying unit that, after the first requesting unit requests the counterpart communication device to perform the power saving operation, specifies a first phase of the power saving operation performed by the counterpart communication device and a second phase corresponding to the first phase in the power saving operation of the station side device, based on communication performed with the counterpart communication device; a difference calculating unit that calculates a difference between the first phase and the second phase specified by the phase specifying unit; and a second requesting unit that requests again the counterpart communication device to perform the power saving operation based on the difference calculated by the difference calculating unit.

A power-saving control system according to a second aspect of the present invention is a power-saving control system that includes a station side device and a subscriber side device, wherein the station side device includes a first requesting unit that requests the subscriber side device to perform a power saving operation of alternately performing execution and suspension of communication at preset time intervals, a phase specifying unit that, after the first requesting unit requests the subscriber side device to perform the power saving operation, specifies a first phase of the power saving operation performed by the subscriber side device and a second phase corresponding to the first phase in the power saving operation of the station side device, based on communication performed with the subscriber side device, a difference calculating unit that calculates a difference between the first phase and the second phase specified by the phase specifying unit, and a second requesting unit that requests again the subscriber side device to perform the power saving operation based on the difference calculated by the difference calculating unit, and the subscriber side device includes a control unit that executes the power saving operation according to a request for the power saving operation from the station side device, a reception unit that receives transmission information indicating a time at which transmission to the station side device is possible during execution of the power saving operation from the station side device, and a transmission unit that transmits predetermined information to the station side device at the time at which transmission is possible, which is indicated by the transmission information received by the reception unit.

A power-saving control method according to a third aspect of the present invention includes a first requesting step of requesting a subscriber side device to perform a power saving operation of alternately performing execution and suspension of communication at preset time intervals; a phase specifying step of, after requesting the subscriber side device to perform the power saving operation in the first requesting step, specifying a first phase of the power saving operation performed by the subscriber side device and a second phase corresponding to the first phase in the power saving operation of a station side device, based on communication performed with the subscriber side device; a difference calculating step of calculating a difference between the first phase and the second phase specified in the phase specifying step; a second requesting step of requesting again the subscriber side device to perform the power saving operation based on the difference calculated in the difference calculating step; a controlling step of executing the power saving operation according to a request for the power saving operation from the station side device; a receiving step of receiving transmission information indicating a time at which transmission to the station side device is possible during execution of the power saving operation from the station side device; and a transmitting step of transmitting predetermined information to the subscriber side device at the time at which transmission is possible, which is indicated by the transmission information received in the receiving step, wherein the first requesting step, the phase specifying step, the difference calculating step, and the second requesting step are performed in the station side device, and the controlling step, the receiving step, and the transmitting step are performed in the subscriber side device.

### Advantageous Effects of Invention

According to the present invention, power can be saved more efficiently in both of the station side device and the subscriber side device.

### BRIEF DESCRIPTION OF DRAWINGS

FIG. 1 is a diagram of a configuration of a power-saving control system according to an embodiment of the present invention.

FIG. 2 is a block diagram of a configuration of a station side device shown in FIG. 1.

FIG. 3 is a block diagram of a configuration of a subscriber side device shown in FIG. 1.

FIG. 4 is a sequence diagram explaining a mutual operation at the time of a normal operation performed between the station side device and the subscriber side devices.

FIG. 5 is a sequence diagram explaining a time during which a power saving operation can be performed in the station side device when different process delay times occur in the devices, respectively.

FIG. 6 is a sequence diagram explaining a time during which a power saving operation can be performed in the station side device when phases of power saving operations are aligned with each other among the devices.

FIG. 7 is a flowchart explaining a process performed by the station side device.

FIG. 8 is a flowchart explaining a process performed by the subscriber side devices.

FIG. 9 is a sequence diagram explaining a mutual operation at the time of a power saving operation performed between the station side device and the subscriber side device.

FIG. 10 is a sequence diagram explaining a mutual operation at the time of a power saving operation performed between the station side device and the subscriber side device.

### DESCRIPTION OF EMBODIMENTS

Exemplary embodiments of a station side device, a power-saving control system, and a power-saving control method according to the present invention will be explained below in detail with reference to the accompanying drawings. The present invention is not limited to the embodiments.

### EMBODIMENT

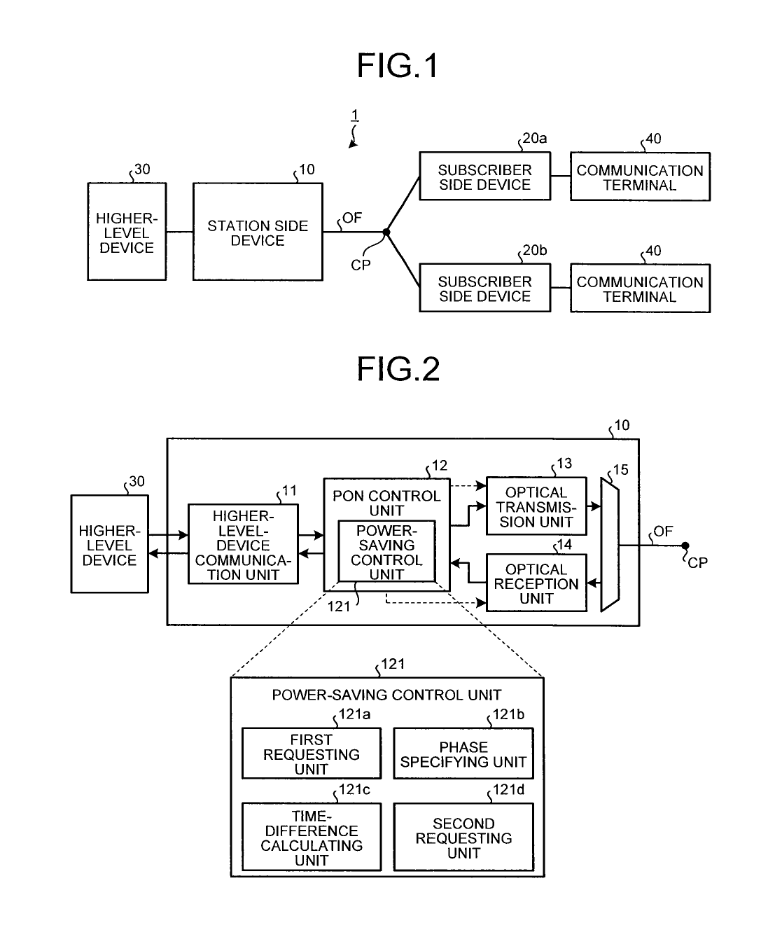

A configuration of a power-saving control system 1 according to the present embodiment is explained first with reference to FIG. 1.

The power-saving control system 1 is a system that includes two types of communication devices, that is, a station side device (OLT) 10 that is placed on the side that provides services and a subscriber side device (ONU) 20 that is placed on the side that uses the services. In this embodiment, a case where the present invention is applied to a GE-PON (Gigabit Ethernet (registered trademark)-PON) system is explained as an example of the power-saving control system 1.

The station side device 10 is connected to the subscriber side devices 20 via a transmission path including an optical fiber cable OF, an optical coupler CP, and the like. While an example where two subscriber side devices 20a and 20b are included is illustrated in this case, it is satisfactory that the number of the subscriber side devices 20 is one or more. In the power-saving control system 1, a direction from the station side device 10 to the subscriber side devices 20 is referred to as “downstream direction” and a direction from the subscriber side devices 20 to the station side device 10 is referred to as “upstream direction”. The station side device 10 switches between a normal operation and a power saving operation when a certain condition is met.

Any method may be used as a method for determining switching between the normal operation and the power saving operation. For example, while the station side device 10 is performing the normal operation, when the amounts of data in the upstream and downstream directions for a certain period of time are below a certain amount (or when no data in the upstream and downstream directions is produced), the station side device 10 requests the subscriber side devices 20 to shift to a power saving mode (power save mode), and, when a notification that the mode has shifted to the power saving mode has been received from all the subscriber side devices 20, the station side device 10 switches from the normal operation to the power saving operation. While the station side device 10 is performing the power saving operation, when the amounts of data in the upstream and downstream directions for the certain period of time exceed the certain amount (or when data in the upstream or downstream direction is produced), the station side device 10 switches from the power saving operation to the normal operation. While the case of using this determination method will be explained below, the method for determining whether the power saving operation is possible is, of course, not limited to this method. The station side device 10 and the subscriber side devices 20 synchronize the clock time with each other and perform time-division multiplex communication as communication in the upstream direction while performing broadcast communication as communication in the downstream communication.

The station side device (OLT) 10 is connected to the higher-level network via a higher-level device 30, such as an L2SW (Layer 2 SWitch). The subscriber side devices 20 are connected to communication terminals 40, such as an HGW (Home Gate Way), a VoIP (Voice over Internet Protocol), and a PC (Personal computer), respectively. One or more communication terminals 40 may be connected to each of the subscriber side devices 20.

A configuration of the station side device 10 shown in FIG. 1 is explained next with reference to FIG. 2. The station side device 10 includes a higher-level-device communication unit 11, a PON control unit 12, an optical transmission unit 13, an optical reception unit 14, and an optical multiplexer/demultiplexer 15.

The higher-level-device communication unit 11 includes an SNI (Service Node Interface) PHY (PHYsical Layer) circuit. The higher-level-device communication unit 11 performs transmission/reception of a signal to/from the higher-level device 30. The higher-level-device communication unit 11 supplies a signal received from the higher-level device 30 to the PON control unit 12. The higher-level-device communication unit 11 receives a main signal representing audio data, image data, and the like as a transmission target from the higher-level device 30. The higher-level-device communication unit 11 transmits a signal received from the PON control unit 12 to the higher-level device 30.

The optical transmission unit 13 converts an electrical signal supplied from the PON control unit 12 into an optical signal and outputs the converted optical signal to the optical fiber cable OF via the optical multiplexer/demultiplexer 15. The optical transmission unit 13 transmits a main signal representing audio data, image data, and the like as a transmission target to the subscriber side devices 20. The main signal includes an address for identifying a transmission destination of data and the like, and each of the subscriber side devices 20 that receive the optical signal receives the main signal only when the transmission destination is its own address.

The optical reception unit 14 converts an optical signal received from the subscriber side devices 20 via the optical fiber cable OF and the optical multiplexer/demultiplexer 15 into an electrical signal and supplies the converted electrical signal to the PON control unit 12.

The optical multiplexer/demultiplexer 15 multiplexes optical signals with a downstream wavelength received from the optical transmission unit 13 and outputs a multiplexed signal to the optical fiber cable OF. The optical multiplexer/demultiplexer 15 demultiplexes a multiplexed optical signal received via the optical fiber cable OF with respect to each wavelength and supplies only an optical signal with an upstream wavelength to the optical reception unit 14.

The PON control unit 12 performs a process of the station side device 10 based on a PON protocol. The PON control unit 12 includes a power-saving control unit 121. The power-saving control unit 121 includes, for example, a CPU (Central Processing Unit), a RAM (Random Access Memory) that functions as a main memory of the CPU, a timer, and the like. The power-saving control unit 121 may be partially constituted by a dedicated circuit such as an ASIC (Application Specific Integrated Circuit). The power-saving control unit 121 switches between the normal operation and the power saving operation based on the amounts of data in the upstream and downstream directions represented by the signals that are received from the higher-level-device communication unit 11 and the optical reception unit 14.

The power-saving control unit 121 functions as a first requesting unit 121a, a phase specifying unit 121b, a time-difference calculating unit (difference calculating unit) 121c, and a second requesting unit 121d. These units 121a to 121d perform various processes explained later.

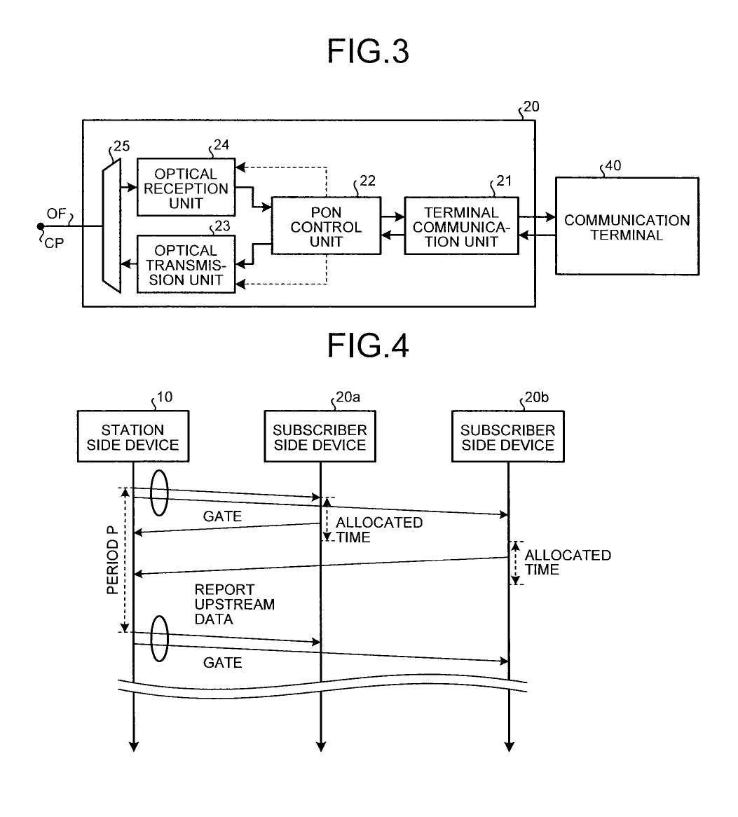

A configuration of the subscriber side devices 20 shown in FIG. 1 is explained next with reference to FIG. 3. Each of the subscriber side devices 20 includes a terminal communication unit 21, a PON control unit 22, an optical transmission unit 23, an optical reception unit 24, and an optical multiplexer/demultiplexer 25.

The terminal communication unit 21 includes a UNI (User Network Interface) PHY circuit. The terminal communication unit 21 performs transmission/reception of a signal to/from the corresponding communication terminal 40. The terminal communication unit 21 supplies a signal received from the communication terminal 40 to the PON control unit 22. The terminal communication unit 21 receives a main signal representing audio data, image data, and the like as a transmission target from the communication terminal 40. The terminal communication unit 21 transmits a signal received from the PON control unit 22 to the communication terminal 40.

The optical transmission unit 23 converts an electrical signal supplied from the PON control unit 22 into an optical signal and outputs the converted optical signal to the optical fiber cable OF via the optical multiplexer/demultiplexer 25.

The optical reception unit 24 converts an optical signal received via the optical fiber cable OF and the optical multiplexer/demultiplexer 25 into an electrical signal and supplies the converted electrical signal to the PON control unit 22. The optical reception unit 24 receives a main signal representing audio data, image data, and the like as a transmission target from the station side device 10.

The optical multiplexer/demultiplexer 25 multiplexes optical signals with an upstream wavelength received from the optical transmission unit 23 and outputs a multiplexed signal to the optical fiber cable OF. The optical multiplexer/demultiplexer 25 demultiplexes a multiplexed optical signal received via the optical fiber cable OF with respect to each wavelength and supplies only an optical signal with a downstream wavelength to the optical reception unit 24.

The PON control unit 22 includes, for example, a CPU, a RAM functioning as a main memory of the CPU, a timer, and the like. The PON control unit 22 can be partially constituted by a dedicated circuit such as an ASIC. The PON control unit 22 shifts to a power saving mode according to a request for shifting to the power saving mode from the station side device 10, and executes a power saving operation explained later.

The normal operation of the power-saving control system 1 having the configuration mentioned above is explained next. In the normal operation, the station side device 10 and the subscriber side devices 20 synchronize the clock time with each other and perform time-division multiplex communication as communication in the upstream direction while performing broadcast communication as communication in the downstream direction.

The station side device 10 allocates to each of the subscriber side devices 20 a time during which communication in the upstream direction from the subscriber side device 20 is possible such that signals in the upstream direction transmitted from the subscriber side devices 20 do not collide in the optical fiber cable OF. The station side device 10 notifies each of the subscriber side devices 20 of the allocated time being contained in a control frame (a GATE frame) as shown in FIG. 4.

In the communication in the upstream direction, each of the subscriber side devices 20 performs the time-division multiplex communication of transmitting various kinds of information at the time allocated to the device itself. The various kinds of information include upstream data such as audio data and image data received from the communication terminal 40, and a control frame (a REPORT frame) that notifies the station side device 10 of the amount of data in the upstream direction and the like.

As described above, during the normal operation, the station side device 10 performs the broadcast communication of the GATE frame to each of the subscriber side devices 20 and each of the subscriber side devices 20 performs the time-division multiplex communication to the station side device 10 according to the time allocated to the device itself. The station side device 10 transmits the GATE frame with a predetermined period (a period P). When the REPORT frame from one of the subscriber side devices 20 to which the communicable time is allocated is not received for a predetermined time length TL (a predetermined number of times) or more, it is considered that any abnormality has occurred in the subscriber side device 20.

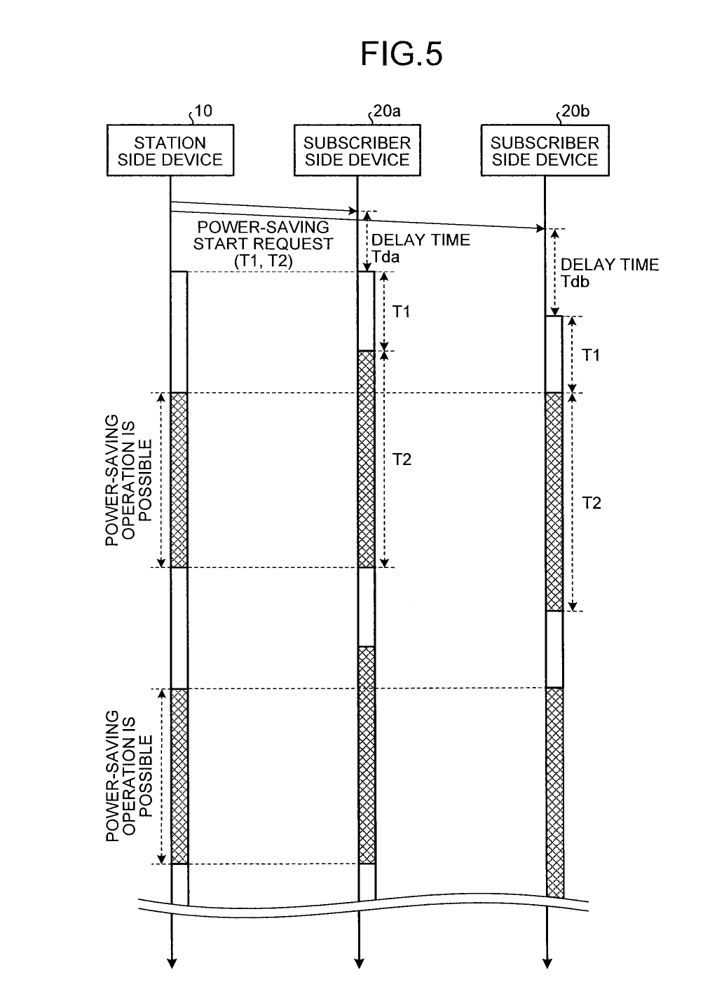

Before the power saving operation of the power-saving control system 1 is explained, an example where the station side device 10 requests each of the subscriber side devices 20 to perform the power saving operation at the same timing is explained next. When the subscriber side devices 20 are brought into the communication suspension state (sleep state) at the same timing, the station side device 10 can be brought into the sleep state during that time. However, even if the station side device 10 sets a time during which communication is suspended and requests to perform the power saving operation according to the suspension time, different process delay times occur in the subscriber side devices 20, respectively, due to the difference in transmission distance, performance of the device, and the like and thus the subscriber side devices 20 cannot start the power saving operation at the same time, as shown in FIG. 5. Therefore, in this case, the station side device 10 can perform the power saving operation only during the time during which all of the subscriber side devices 20 (20a and 20b) are in the communication suspension state at the same time (time during which all the suspension times overlap with each other).

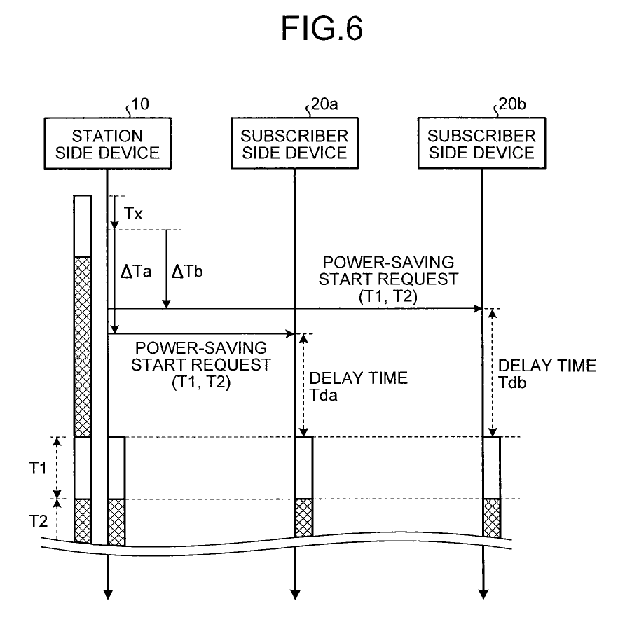

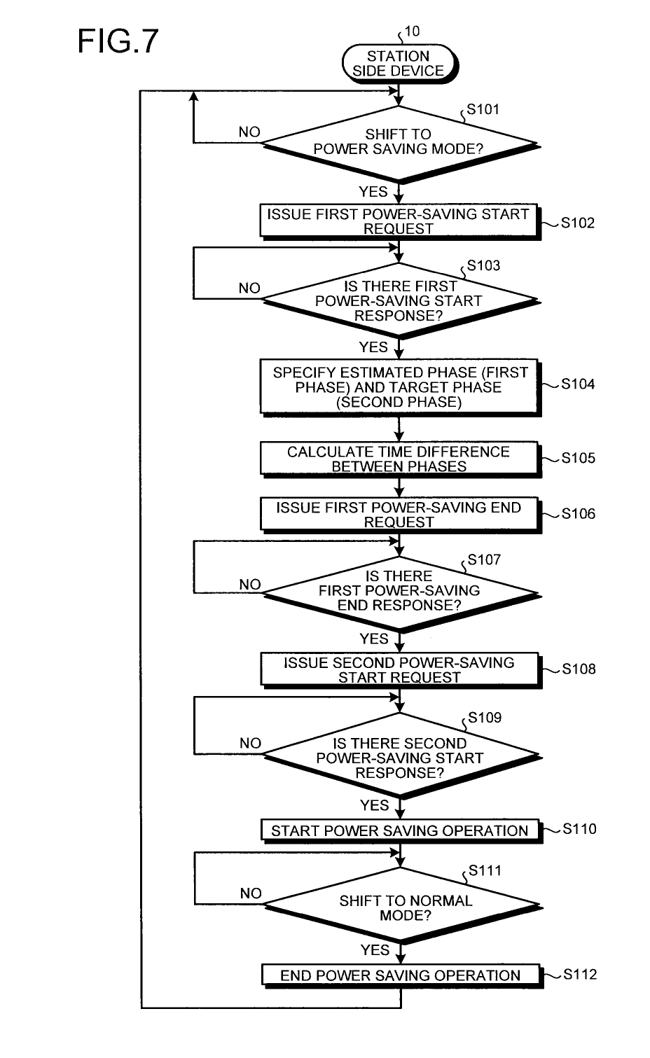

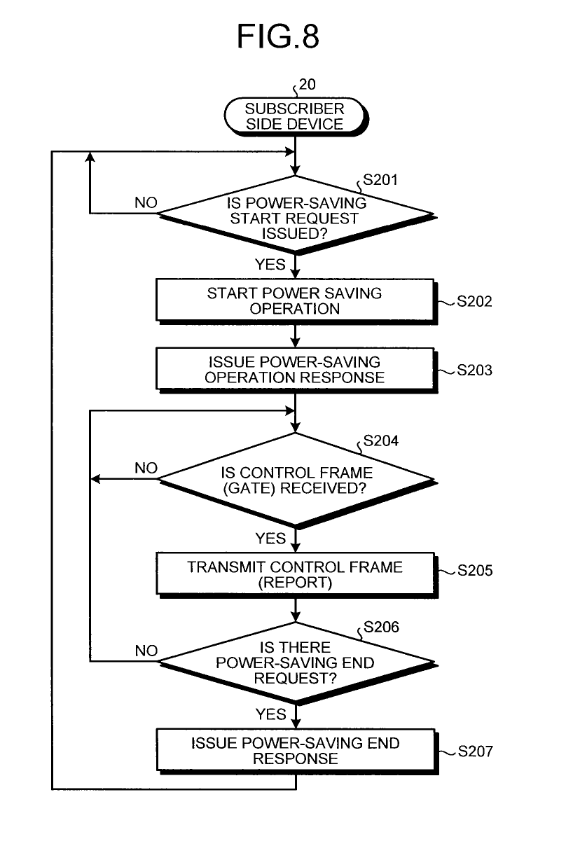

The power saving operation of the power-saving control system 1 is explained below with reference to FIGS. 7 and 8. According to this power saving operation, even when different process delay times occur in the subscriber side devices 20, respectively, the station side device 10 obtains information for aligning the phases of the periods of the power saving operations with each other among the subscriber side devices 20 (time differences ΔTa and ΔTb shown in FIG. 6) so that the subscriber side devices 20 can be brought into the communication suspension state (the sleep state) at the same timing (in a state where the phases of the periods of the power saving operations are aligned with each other). In this case, in the communication suspension state (the sleep state), both of the optical transmission unit 23 and the optical reception unit 24 in each of the subscriber side devices 20 may be suspended (the transmission and reception functions may be suspended) or only the optical transmission unit 23 may be suspended (the transmission function may be suspended). The power saving operation indicates an operation of alternately performing the communication suspension state (the sleep state) and the normal operation (a temporarily activated state) at predetermined time intervals. A state of the subscriber side devices 20 that perform the power saving operation is referred to as “power saving mode” as appropriate and a shift from the normal operation state to the power saving state is referred to as “shift to the power saving mode” as appropriate. The phase of the period of the power saving operation (hereinafter, referred to simply as “phase” as appropriate) indicates an arbitrary time position in the period of the power saving operation and, for example, indicates a start time of the power saving operation.

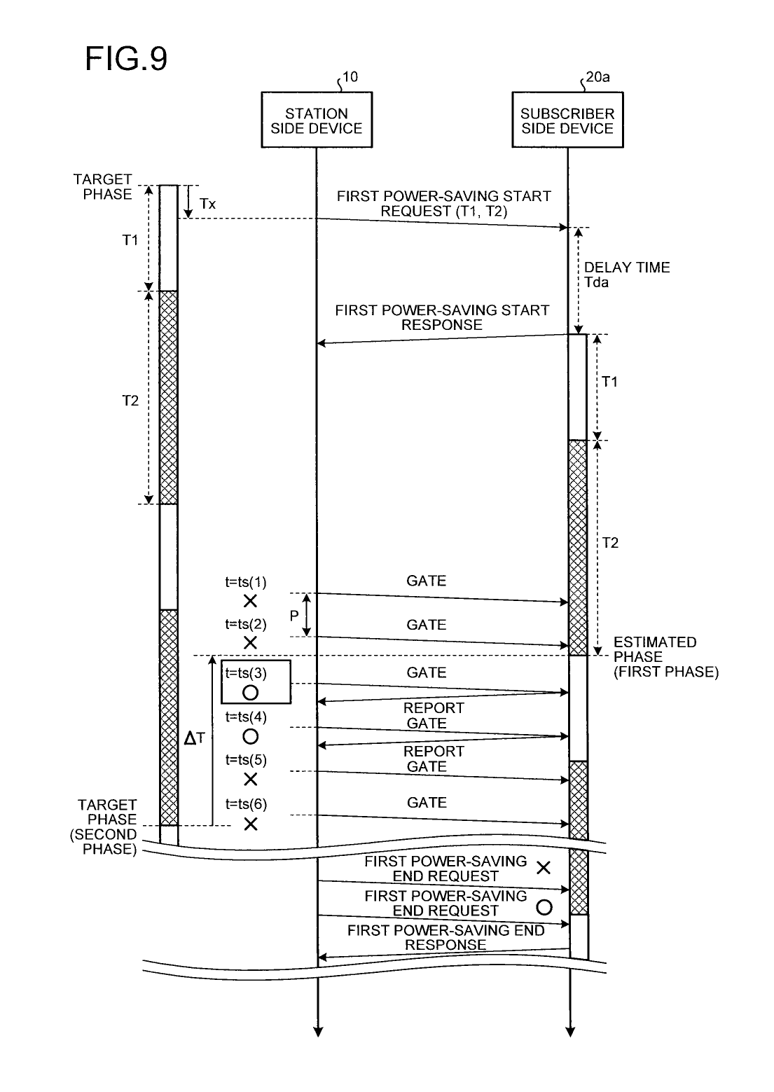

As shown in FIG. 7, after the station side device 10 is powered on, the first requesting unit 121a of the station side device 10 calculates the amounts of data in the upstream and downstream directions received from the higher-level-device communication unit 11 and the optical reception unit 14 with respect to each of the subscriber side devices 20 and determines whether to perform the power saving operation in each of the subscriber side devices 20 based on whether these amounts of data for a certain period of time is below a certain amount (Step S101). When the amounts of data in the upstream and downstream directions for the certain period of time exceed the certain amount, the first requesting unit 121a determines not to perform the power saving operation (NO at Step S101) and performs the normal operation mentioned above. In contrast, when the amounts of data in the upstream and downstream directions for the certain period of time are below the certain amount (or when no data in the upstream and downstream directions is produced), the first requesting unit 121a determines to perform the power saving operation (YES at Step S101). In this case, the first requesting unit 121a requests the subscriber side devices 20 (the subscriber side device 20a in FIG. 9) to perform a first power saving operation (to shift to the power saving mode) with a communication execution time (T1) and a suspension time (T2), which are previously set and recorded in the memory (Step S102).

The first requesting unit 121a sets an arbitrary time position in the power saving operation that is constituted by the execution time (T1) and the suspension time (T2) as a target phase and records the target phase in the memory. For example, as shown in FIG. 9, a start position of the execution time (T1) of the power saving operation is set as the target phase. The first requesting unit 121a records the time (Tx shown in FIG. 9) from the start position of the power saving operation (a start point of T1) until the first power saving operation is requested in the memory.

Meanwhile, as shown in FIG. 8, the PON control unit 22 of each of the subscriber side devices 20 determines whether a request for the power saving operation is issued from the station side device 10 after its own subscriber side device 20 is powered on (Step S201). The PON control unit 22 performs the normal operation mentioned above until the request for the power saving operation is issued (NO at Step S201). In contrast, when the PON control unit 22 determines that the request for the power saving operation is issued (YES at Step S201), the PON control unit 22 starts the power saving operation constituted by the execution time (T1) and the suspension time (T2) according to the request from the station side device 10 after a given process delay time (Tda) (Step S202). The PON control unit 22 sends to the station side device 10 a response indicating that the power saving operation has been started (Step S203).

The description refers back to FIG. 7. When the phase specifying unit 121b of the station side device 10 determines that there is a response from the subscriber side device 20 indicating that the power saving operation has been started (YES at Step S103), the phase specifying unit 121b of the station side device 10 specifies a phase (an estimated phase; first phase) corresponding to the target phase mentioned above in the power saving operation of the subscriber side device 20, and specifies its own target phase (second phase) immediately after the estimated phase (Step S104).

The estimated phase (first phase) can be specified by performing the time-division multiplex communication as the communication in the upstream direction and performing the broadcast communication as the communication in the downstream direction. After the response indicating that power saving has been started is received from the subscriber side device 20, the phase specifying unit 121b transmits the GATE frame and receives the REPORT frame in a similar manner to the normal operation mentioned above, as shown in FIG. 9. The phase specifying unit 121b determines the time at which the GATE frame is transmitted and whether the subscriber side device 20 has been in the power-saving execution time (T1) when the GATE frame has reached the subscriber side device 20 based on whether the REPORT frame is received. For example, the station side device 10 has not received the REPORT frame at a time t=ts(2); however, the station side device 10 has received the REPORT frame at a time t=ts(3). Accordingly, the phase specifying unit 121b can specify that the start position of the execution time (T1) of the power saving operation is between the times t=ts(2) and ts(3) and can specify that the estimated phase corresponding to the preset target phase is, for example, at (ts(2)+ts(3))/2. When the transmission period P of the GATE frame is set shorter, the estimated phase can be obtained more correctly. Alternatively, the estimated phase may be specified in consideration of an RTT (Round Trip Time), instead of by obtaining the average.

Its own target phase (second phase) immediately after the estimated phase is specified based on the time of the estimated phase (for example, ts(2)+ts(3)/2) and a period (T1+T2) of its own power saving operation.

The time-difference calculating unit (difference calculating unit) 121c calculates a time difference (ΔT) between the estimated phase and the target phase specified by the phase specifying unit 121b (Step S105). The PON control unit 12 then requests each of the subscriber side devices 20 (the subscriber side device 20a in FIG. 9) to end the first power saving operation (Step S106).

Meanwhile, in FIG. 8, the PON control unit 22 of the subscriber side device 20a repeatedly performs a process of transmitting the REPORT frame responding to the GATE frame received from the station side device 10 to the station side device 10 at the time allocated by the station side device 10 during the normal operation (the temporarily activated state) in the power saving operation until the station side device 10 requests an end of the power saving operation (a shift to the normal mode) (YES at Step S204 and Step S205).

When the PON control unit 22 determines that an end of the power saving operation is requested from the station side device 10 (YES at Step S206), the PON control unit 22 issues a response to end the power saving operation to the station side device 10 (Step S207). The PON control unit 22 then ends the power saving operation being executed and performs the normal operation mentioned above.

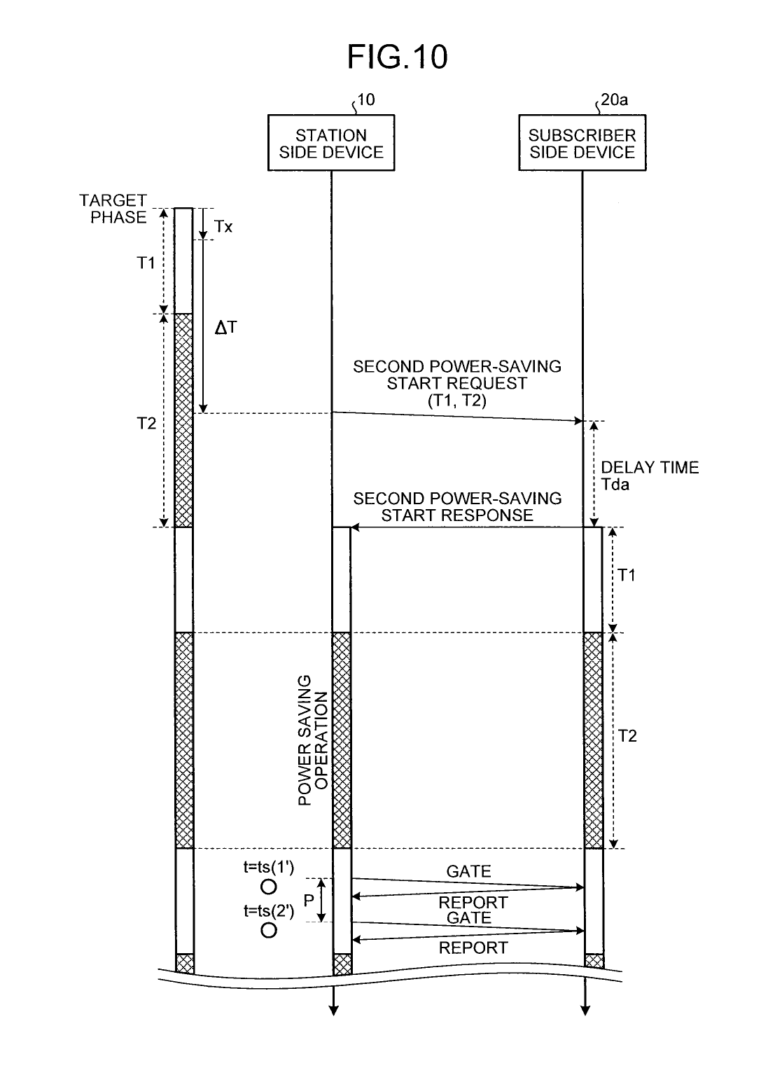

The description refers back to FIG. 7. When the second requesting unit 121d of the station side device 10 determines that there is a response from the subscriber side device 20 indicating that the power saving operation has been ended (YES at Step S107), the second requesting unit 121d of the station side device 10 requests again to perform a second power saving operation after a delay of the time difference (ΔT) calculated by the time-difference calculating unit 121c from the timing at which the first requesting unit 121a requests the power saving operation (Step S108). For example, the second requesting unit 121d requests to perform the second power saving operation after a delay of the time (Tx shown in FIG. 9) from the start time of its own power saving operation (the start position of T1) until the first power saving operation is requested and the time difference (ΔT), as shown in FIG. 10. Accordingly, the phases of the periods of the power saving operations by the station side device 10 and the subscriber side device 20 can be aligned with each other. When the phase misalignment between the periods of the power saving operations of the station side device 10 and all the subscriber side devices 20 falls equal to or below a predetermined value, the station side device 10 starts its own power saving operation.

For example, in a case where the process delay time (Tda) fluctuates, even when the second power saving operation is requested after a delay of the time difference (ΔT), misalignment may occur between the periods of the power saving operations. In such a case, an estimated phase is calculated in the procedure mentioned above to confirm that the estimated phase is aligned with the target phase (period misalignment is calculated). When the phases are not aligned with each other (the calculated misalignment is equal to or larger than a predetermined value), the second requesting unit 121d repeats the same procedure, thereby enabling the misalignment occurring due to the fluctuations of the process delay time (Tda) or the like to be reduced. Furthermore, the clock times managed by the subscriber side devices 20 may be displaced from that of the station side device 10 and misalignment may occur between the phases of the power saving operations resulting from the displacement. Accordingly, it may be always or periodically confirmed in the procedure mentioned above that the estimated phase falls within the target phase.

Meanwhile, as shown in FIG. 8, when the PON control unit 22 of the subscriber side device 20 determines that a request for the power saving operation is issued from the station side device 10 (YES at Step S201), the PON control unit 22 of the subscriber side device 20 starts the power saving operation constituted by the execution time (T1) and the suspension time (T2) according to the request from the station side device 10 after the given process delay time (Tda) as in the process mentioned above (Step S202). The PON control unit 22 issues a response indicating that the power saving operation has been started to the station side device 10 (Step S203).

When the second requesting unit 121d of the station side device 10 determines that the response indicating that the power saving operation has been started is issued from the subscriber side device 20 (YES at Step S109), the second requesting unit 121d of the station side device 10 starts the power saving operation when the phases of the periods of the power saving operations of the station side device 10 and all the subscriber side devices 20 are aligned with each other (including a case where misalignment between the phases of the power saving operations is equal to or smaller than the predetermined value) (Step S110). The second requesting unit 121d then performs the power saving operation until it is determined that the amounts of data in the upstream and downstream directions received from the higher-level-device communication unit 11 and the optical reception unit 14 for the certain period of time exceed the certain amount (YES at Step S111). In contrast, when the second requesting unit 12d determines that the amounts of data for the certain period of time exceed the certain amount (YES at Step S111), the second requesting unit 12d ends the power saving operation (Step S112) and performs the normal operation mentioned above.

While communication exchange performed between the station side device 10 and one subscriber side device 20a has been explained for convenience of explanation, the station side device 10 calculates a difference in phase from all the subscriber side devices 20, requests the second power saving operations based on the calculated phase differences, and aligns the phases of the periods of the power saving operations of the station side device 10 and all the subscriber side devices 20 with each other.

While the case where the periods (T1+T2) of the power saving operations of the subscriber side devices 20 are equal has been explained, the periods of the power saving operations of the subscriber side devices 20 may be different from each other. Particularly, when the periods of the power saving operations in the states designated to the subscriber side devices 20 are integer multiples of each other, effects of the present invention become greater. For example, when the power saving period of the subscriber side device 20a is T1+T3 and the power saving period of the subscriber side device 20b is T1+T3, the station side device 10 can perform the power saving operation with a period of T1+T2 also when T1+T3=2×(T1+T2).

As explained above, according to the present embodiment, the phases of the power saving operations of the station side device 10 and each of the subscriber side devices 20 can be aligned with each other and therefore power can be saved more efficiently in both of the station side device 10 and the subscriber side devices 20.

The phase specifying unit 121b may specify the estimated phase based on the time at which the station side device 10 receives a response (the REPORT frame) to the transmission information indicating the time at which transmission to its own device is possible from the subscriber side devices 20.

Before aligning the phases of the power saving operations of all the subscriber side devices 20, the second requesting unit 121d may specify the time during which communication in its own device can be suspended (the time during which the suspension times T2 of all the subscriber side devices 20 overlap with each other) at a predetermined timing, thereby bringing communication of the subscriber side devices 20 into the communication suspension state during the specified time.

The time-difference calculating unit 121c may record the calculated time difference with respect to each of the subscriber side devices 20 and the first requesting unit 121a may request each of the subscriber side devices 20 to perform the power saving operation based on the time difference corresponding to the subscriber side device 20, recorded by the time-difference calculating unit 121c. In this way, the phases of the power saving operations of the station side device 10 and each of the subscriber side devices 20 can be promptly aligned with each other.

The station side device 10 and the subscriber side devices 20 according to the present invention can each be realized by a general computer. In this case, the procedure explained in the present embodiment is executed by the computers. The computers each perform the operation explained in the embodiment according to programs. The programs may be recorded in a portable recording medium, or the like. The portable recording medium is a CD-ROM, a DVD-ROM, or a BD-ROM, for example. The programs may be installed into the station side device 10 and the subscriber side devices 20 from the portable recording medium via various kinds of readers. Furthermore, the programs may be downloaded via the Internet or the like and installed into the station side device 10 and the subscriber side devices 20. The programs may be stored in storage devices such as a server that can communicate with the station side device 10 and each of the subscriber side devices 20. The configurations of the station side device 10 and each of the subscriber side devices 20 may be realized using hardware.

In addition, the present invention is not limited to the explanations of the above embodiment and the drawings, and the above embodiment and the drawings can be modified as appropriate.

### REFERENCE SIGNS LIST

1 power-saving control system (PON system), 10 station side device, 11 higher-level-device communication unit, 12 PON control unit, 121 power-saving control unit, 121a first requesting unit (first requesting unit), 121b phase specifying unit (phase specifying unit), 121c time-difference calculating unit (difference calculating unit), 121d second requesting unit (second requesting unit), 13 optical transmission unit, 14 optical reception unit, 15 optical multiplexer/demultiplexer, 20, 20a, 20b subscriber side device, 21 terminal communication unit, 22 PON control unit, 23 optical transmission unit, 24 optical reception unit, 25 optical multiplexer/demultiplexer, 30 higher-level device, 40 communication terminal, OF optical fiber cable, CP optical coupler.

1. A station side device comprising:
a first requesting unit that requests a counterpart communication device to perform a power saving operation of alternately performing execution and suspension of communication at preset time intervals;
a phase specifying unit that, after the first requesting unit requests the counterpart communication device to perform the power saving operation, specifies a first phase of the power saving operation performed by the counterpart communication device and a second phase corresponding to the first phase in a power saving operation of the station side device, based on communication performed with the counterpart communication device;
a difference calculating unit that calculates a difference between the first phase and the second phase specified by the phase specifying unit; and
a second requesting unit that requests again the counterpart communication device to perform the power saving operation based on the difference calculated by the difference calculating unit.

2. The station side device according to claim 1, wherein the phase specifying unit specifies a phase in the power saving operation of the counterpart communication device, corresponding to a phase of the power saving operation of the station side device, as the first phase, based on communication performed with the counterpart communication device.

3. The station side device according to claim 2, wherein the phase specifying unit specifies the first phase based on a time at which transmission information indicating a time at which transmission to the station side device is possible is transmitted to the counterpart communication device and whether there is a response from the counterpart communication device to which the transmission information has been transmitted.

4. The station side device according to claim 2, wherein the phase specifying unit specifies the first phase based on a time at which a response is received from the counterpart communication device to which transmission information indicating a time at which transmission to the station side device is possible is transmitted.

5. The station side device according to claim 1, wherein
a plurality of counterpart communication devices are present, and
the second requesting unit requests again the counterpart communication devices to perform the power saving operation based on the difference that is calculated by the difference calculating unit and corresponds to each of the counterpart communication devices.

6. The station side device according to claim 5, wherein the second requesting unit specifies a time at which the communication in the station side device is capable of being suspended and suspends the communication at the time at which the communication is capable of being suspended.

7. The station side device according to claim 1, wherein
a plurality of counterpart communication devices are present,
the difference calculating unit records a calculated difference between the first phase and the second phase with respect to each of the counterpart communication devices, and
the first requesting unit requests the counterpart communication devices to perform the power saving operation based on the calculated difference corresponding to each of the counterpart communication devices, recorded by the difference calculating unit.

8. The station side device according to claim 1, further comprising
a period-misalignment calculating unit that calculates a period misalignment between a period of the power saving operation of the counterpart communication device requested by the second requesting unit and a period of the power saving operation of the station side device, wherein
when the period misalignment calculated by the period-misalignment calculating unit is equal to or larger than a predetermined value, the second requesting unit requests the counterpart communication device to perform the power saving operation based on the period misalignment.

9. The station side device according to claim 5, wherein the counter communication devices perform the power saving operation with periods that are integer multiples of each other.

10. A power-saving control system, comprising a station side device and a subscriber side device, wherein
the station side device comprises
a first requesting unit that requests the subscriber side device to perform a power saving operation of alternately performing execution and suspension of communication at preset time intervals,
a phase specifying unit that, after the first requesting unit requests the subscriber side device to perform the power saving operation, specifies a first phase of the power saving operation performed by the subscriber side device and a second phase corresponding to the first phase in a power saving operation of the station side device, based on communication performed with the subscriber side device,
a difference calculating unit that calculates a difference between the first phase and the second phase specified by the phase specifying unit, and
a second requesting unit that requests again the subscriber side device to perform the power saving operation based on the difference calculated by the difference calculating unit, and
the subscriber side device comprises
a control unit that executes the power saving operation according to a request for the power saving operation from the station side device,
a reception unit that receives transmission information indicating a time at which transmission to the station side device is possible during execution of the power saving operation from the station side device, and
a transmission unit that transmits predetermined information to the station side device at the time at which transmission is possible, which is indicated by the transmission information received by the reception unit.

11. A method for controlling power-saving, the method comprising:
(i) requesting a subscriber side device to perform a power saving operation of alternately performing execution and suspension of communication at preset time intervals;
(ii) subsequently specifying a first phase of the power saving operation performed by the subscriber side device and a second phase corresponding to the first phase in a power saving operation of a station side device, based on communication performed with the subscriber side device;
(iii) calculating a difference between the first phase and the second phase specified in said specifying (ii);
(iv) requesting again the subscriber side device to perform the power saving operation based on the difference calculated in said calculating (iii);
(v) executing the power saving operation according to a request for the power saving operation from the station side device;
(vi) receiving transmission information indicating a time at which transmission to the station side device is possible during execution of the power saving operation from the station side device; and
(vii) transmitting predetermined information to the subscriber side device at the time at which transmission is possible, which is indicated by the transmission information received in said receiving,
wherein
said requesting (i), said specifying (ii), said calculating (iii), and said requesting (iv) are performed in the station side device, and
said executing (v), said receiving (vi), and said transmitting (vii) are performed in the subscriber side device.
